(19) United States
(12) Patent Application Publication
(10) Pub. No.: US 2009/0217790 A1
(43) Pub. Date: Sep. 3, 2009

(54) Universal adjustable wrench with tactile snap action

(76) Inventor: Robert J. Harter, La Crosse, WI (US)

Correspondence Address: ROBERT J. HARTER, 4233 CLIFFSIDE DRIVE, LA CROSSE, WI, 54601, US

(21) Appl. No.: 12/072,852

(22) Filed: Feb. 28, 2008

(51) Int. Cl. B25B 13/12; B25B 13/02; B25B 13/00

(52) U.S. Cl. 81/129; 81/119; 81/186

(57) ABSTRACT

An adjustable wrench for gripping hexagonal and other shaped heads includes two slightly non-parallel jaw faces, wherein one face is smoother than the other. The angle between the two jaw faces is extremely shallow to create a “snap-action” geometry. Combining that geometry with jaw faces of unequal roughness can result in a desirable binding action that causes the wrench to tightly grip the head. In some cases, the wrench will continue clinging to the head even after the user releases the handle of the wrench.

### FIELD OF THE INVENTION

The subject invention generally pertains to adjustable spanner wrenches and more specifically to the jaws of such a wrench.

### BACKGROUND OF RELATED ART

Adjustable spanner wrenches are typically used for tightening hexagonal nut and bolt heads. Although the span between the parallel jaw faces is adjustable to fit hexagonal and square heads of various sizes, some clearance between the head and the jaw is often needed in order to slide the wrench onto the head. Such clearance, however, can cause the wrench to accidentally slip off the head. If a bolt or nut is particularly tight, the wrench might round the corners of the head, which can make the head even more difficult to grip. Consequently, there is a need for a better adjustable wrench.

### SUMMARY OF THE INVENTION

It is an object of the present invention to provide an adjustable wrench with slightly non-parallel jaw faces for tightly gripping opposite parallel faces of a hexagonal head.

Another object of some embodiments is to provide a tightly gripping adjustable wrench that does not rely on one jaw having to pivot relative to another.

Another object of some embodiments is to provide an adjustable wrench with a single set of jaws that can grip hexagonal, square, round, and pentagonal heads.

Another object of some embodiments is to provide a wrench that tightens its grip on a head by way of rotating the entire wrench as a unit (i.e., one wrench component does not have to move relative to another wrench component). In some cases, the resulting grip becomes so tight that even after the user releases the wrench's handle, the wrench continues to hang onto the head all by itself.

Another object of some embodiments is to provide an adjustable wrench that can engage a hexagonal head by inserting the head into the wrench's jaws in a direction nearly inline with the longitudinal axis of the wrench's handle. In other words, the angle between the handle and the direction in which the adjustable jaw moves is twenty to ninety degrees.

Another object of some embodiments is to provide a set of jaws with jaw faces that are generally planar, although one jaw face may be roughened with a series of teeth.

Another object of some embodiments is to provide an adjustable wrench with a set of jaws wherein one jaw face is smoother than the other.

Another object of some embodiments is to provide a wrench with diverging jaw faces that provide a settling-in ratio of 0.25 to 0.26 with respect to a perfect hexagon, thereby providing a tight fitting grip with an actual hexagonal head.

Another object of some embodiments is to provide a jaw design (slightly diverging jaw faces with one face rougher than the other) that can be applied to wrenches with either an adjustable jaw opening (e.g., adjustable spanner) or a fixed jaw opening (e.g., open-end wrench).

Another object of some embodiments is to provide an adjustable wrench with diverging jaws that define a vertex that extends beyond the length of the wrench's handle when the wrench is fully open, or extends at least half the wrench's overall length.

Another object of some embodiments is to provide wrench with just one relatively smooth jaw face having a surface roughness of less than 125 microinches.

Another object of some embodiments is to roughen the surface of a jaw by depositing a carbide-alloy coating (e.g., tungsten carbide) on the jaw's face.

Another object of some embodiments is to provide a wrench with a theoretical snap-in feature that in some real situations translates to a tight gripping/binding action on various shaped heads.

One or more of these and/or other objects of the invention are provided by a wrench with two jaw faces that diverge at a certain unique angle, wherein one jaw face is rougher than the other to create a certain settling-in ratio, a certain snap-in feature, and/or a certain binding action for firmly gripping heads of various shapes.

### BRIEF DESCRIPTION OF THE DRAWINGS

FIG. 1 is a front view of a wrench shown in relation to a hexagon (mathematical model).

FIG. 2 is an enlarged front view of FIG. 1 illustrating a state of equilibrium (second state of equilibrium).

FIG. 3 is an enlarged front of FIG. 2 but illustrating another state of equilibrium (first state of equilibrium).

FIG. 4 is an enlarged front view of FIG. 2.

FIG. 5 is a front view similar to FIGS. 3 and 4 but illustrating an intermediate state.

FIG. 6 is a front view showing a comparison of FIGS. 3-5.

FIG. 7 is a front view similar to FIG. 4 but showing an alternate jaw face.

FIG. 8 is a front view similar to FIG. 7 but showing yet another alternate jaw face.

### DESCRIPTION OF THE PREFERRED EMBODIMENT

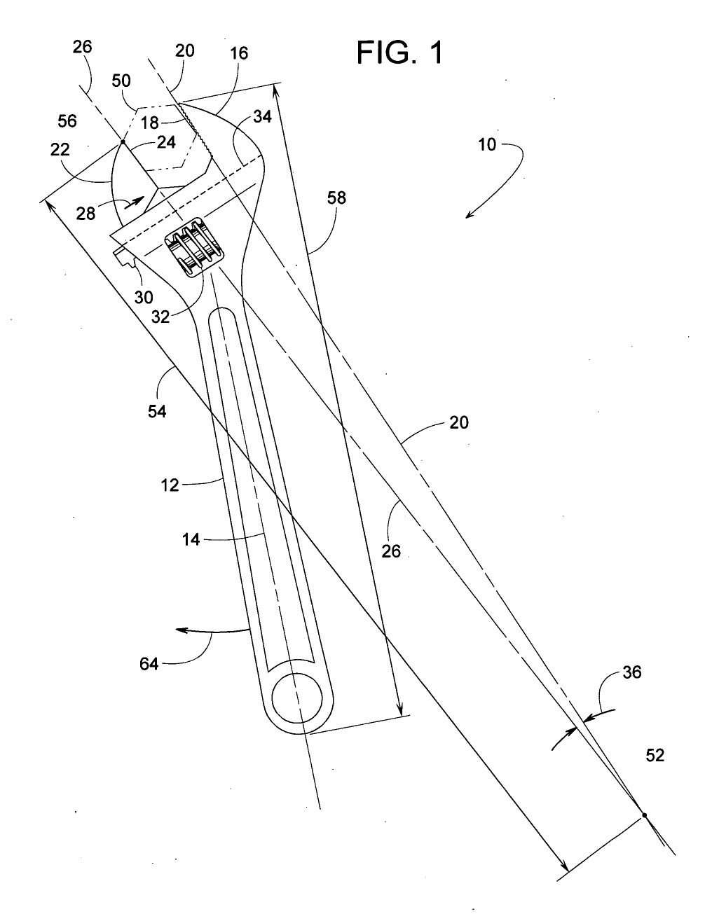

FIGS. 1-6 show an adjustable wrench 10 adapted to grip a polygonal head including, but not limited to, a hexagonal head. Wrench 10 comprises a handle 12 defining a longitudinal axis 14, a first jaw 16 connected to handle 14 and having a first jaw face 18 that defines a first plane 20, and a second jaw 22 connected to handle 12 and having a second jaw face 24 that defines a second plane 26. In the case where handle 12 happens to be curved, longitudinal axis 14 is defined as the best fitting linear neutral axis of the curved shape. The expression of a jaw being connected to a handle means that the two are in some way coupled to each other or one is an integral extension of the other.

Jaws 16 and 22 are movable in substantially linear translation relative to each other so that wrench 10 can be moved in an adjustment direction 28 to receive heads of various sizes and shapes (e.g., hexagonal, pentagonal, square, round, irregular, etc.). Due to the wrench's ability to grip a variety of shapes, wrench 10 preferably includes only one set of jaws 16 and 22. For the illustrated example, first jaw 16 is fixed relative to handle 12, and second jaw 22 is adjustably movable relative to jaw 16 and handle 12; however, it is well within the scope of the invention to have either jaw 16 or 22 be the one that is movable relative to handle 12.

The adjustable jaw, such as jaw 22, could be moved by any one of a variety of known drive mechanisms including, but not limited to, manually sliding jaw 22 directly. For illustration, jaw 22 is shown being moved by a toothed gear rack 30 that meshes with a manually or otherwise rotatable worm gear 32. Rack 30 rigidly extends from jaw 22 and slides along a channel 34 in wrench 10. Depending on which direction worm gear 32 is rotated, rack 30 and jaw 22 move in or out to respectively close or open wrench 10.

Jaws 16 and 22 have a special geometry that provides wrench 10 with some unique benefits. One, the jaw's geometry can eliminate the clearance or play that typically exists during fit-up between a standard wrench and a hexagonal head just prior to rotating the wrench. And, two, the geometry can provide a tactile “snap-in” feel as wrench 10 settles into driving engagement with a hexagonal head. The geometry is also useful for gripping round or irregular shapes such as a worn hexagonal head with rounded corners.

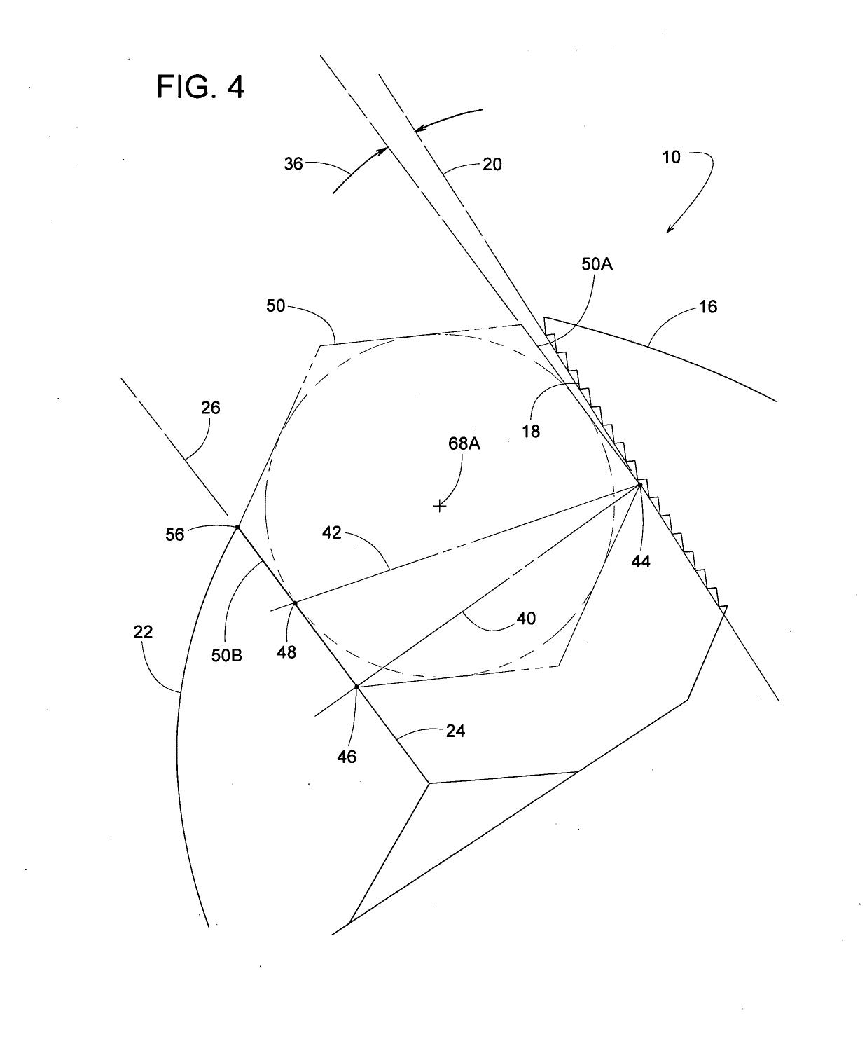

To achieve such benefits, jaw faces 18 and 24 diverge at a slight jaw angle 36, and one jaw face is smoother than the other, e.g., jaw face 24 is smoother than jaw face 18. Angle 36 is measured with reference to planes 20 and 26. Planes 20 and 26 are defined as planes that lie along their respective jaw faces 18 and 24. In the case where a jaw face includes a plurality of teeth 38 (e.g., jaw 16), its associated plane (e.g., plane 20) would lie along the peaks of teeth 38. Angle 36 should be greater than zero degrees and preferably less than 15 degrees for satisfactory results. More solid engagement and less slippage with a hexagonal head are achieved when angle 36 is between 2 and 8 degrees. The 8-degree angle limit is approximately the angle created by two lines 40 and 42 of FIG. 4, wherein line 40 passes through two engagement points 44 and 46 of a hexagon 50, and line 42 passes through point 44 and an approximate midpoint 48 of one side of hexagon 50. If angle 36 becomes too close to zero degrees (e.g., one degree), jaws 16 and 22 tend to bind excessively to a round head. Angle 36 being about 4 degrees (plus or minus one degree) appears to be the currently preferred optimum.

Due to jaw angle 36, planes 20 and 26 intersect at a vertex 52. Angle 36 and the jaw adjustment of wrench 10 preferably place vertex 52 at a great distance from jaws 16 and 22 when the jaws are fully open (i.e., at their maximum open position). Specifically, when the jaws are fully open, a distance 54 from vertex 52 to a distal tip 56 of jaw 22 is preferably greater than an overall length 58 of wrench 10 or at least greater than half of length 58. Such a geometry provides an enhanced gripping function with respect to the workpiece and minimizes the manual pressure it take to force the wrench into a self-gripping relationship with the workpiece.

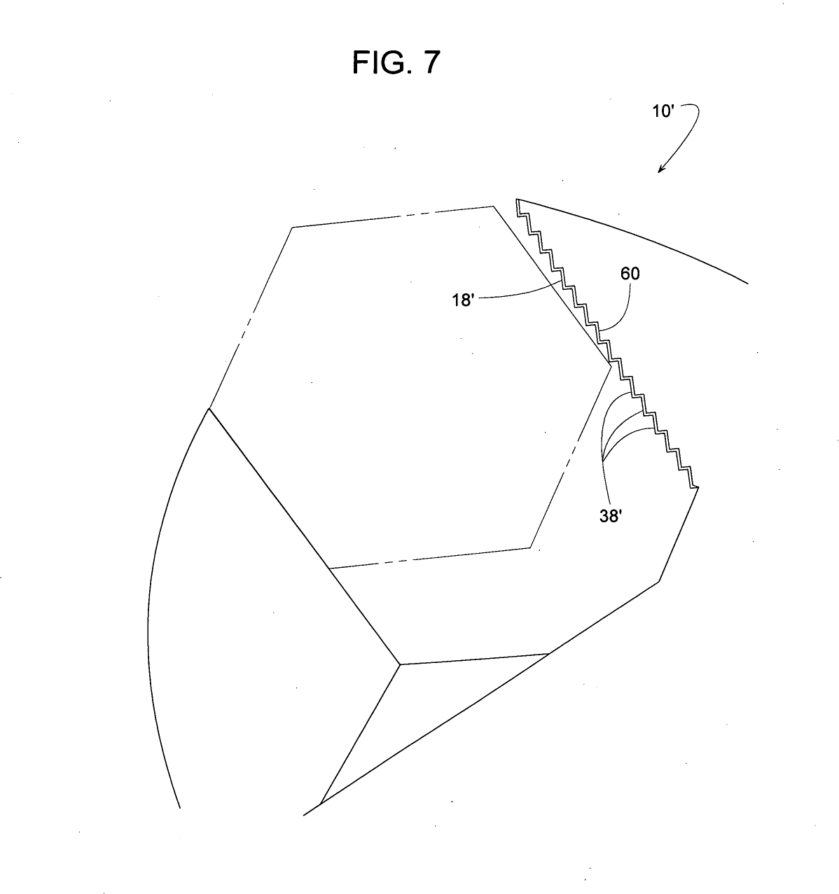

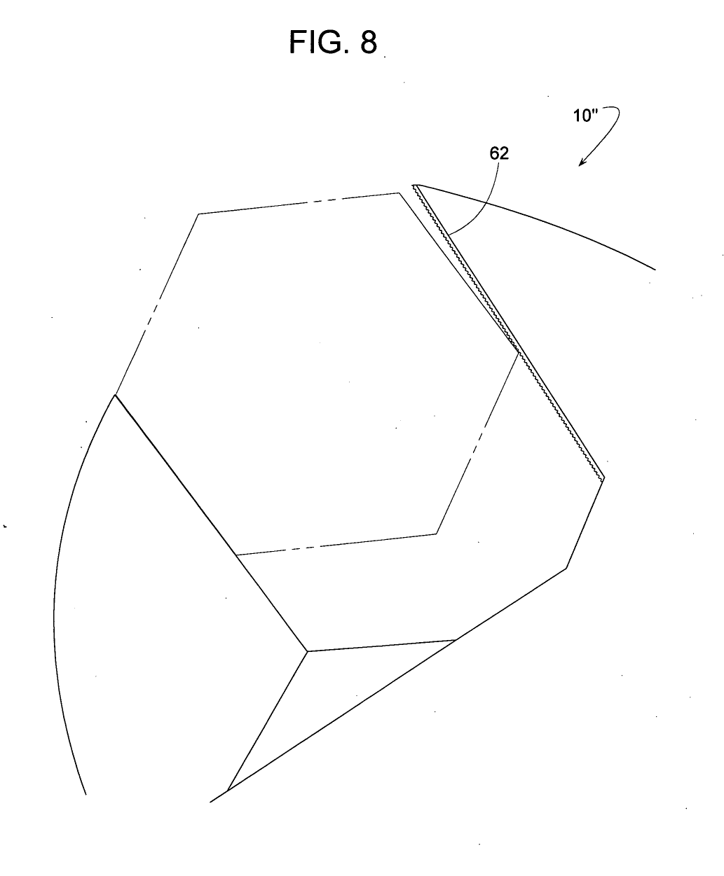

The ability of wrench 10 to effectively grip a workpiece is due in part to one jaw being rougher than the other. Making jaw face 18 rougher than jaw face 24, or vice versa, can be achieve in various ways including, but not limited to, teeth 38, knurling, random irregularities, high-friction or rough coatings, and various combinations thereof. FIG. 7, for example, shows a wrench 10′ with a relatively rough jaw face 18′ having a plurality of teeth 38′ plus a rough coating 60. FIG. 8 shows a wrench 10″ with just a rough coating 62 (e.g., 0.002″ thick). Coatings 60 and 62 can be a carbide alloy such as tungsten carbide deposited using a model 55 applicator gun and a 8211 tungsten carbide electrode provided by Rocklin Manufacturing Company of Sioux City, Iowa. Other coatings are certainly conceivable and well within the scope of the invention.

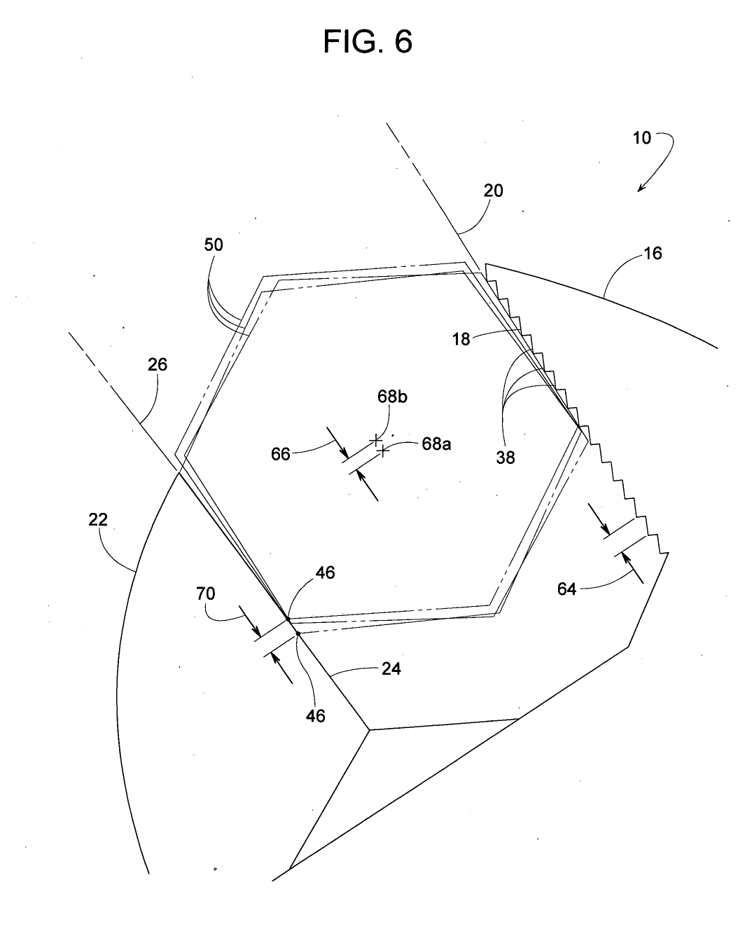

Although the shape, size and number of teeth 38 may vary, in a currently preferred embodiment, teeth 38 have about a 90-degree apex (peak angle) and are distributed at about a pitch distance 64 of 0.050″ increments (FIG. 6). Teeth 38 preferably lean about 20-degrees inward toward vertex 52.

The smoother jaw face, e.g., jaw face 24, preferably has an Ra value (roughness average value) of less than 125 microinches. Thus, the rougher jaw face, e.g., jaw face 18, should have an Ra value appreciably greater than that.

The operation of wrench 10 will be described with reference to hexagon 50 and planes 20 and 26. Hexagon 50 and planes 20 and 26 are mathematical representations and not necessarily physically real.

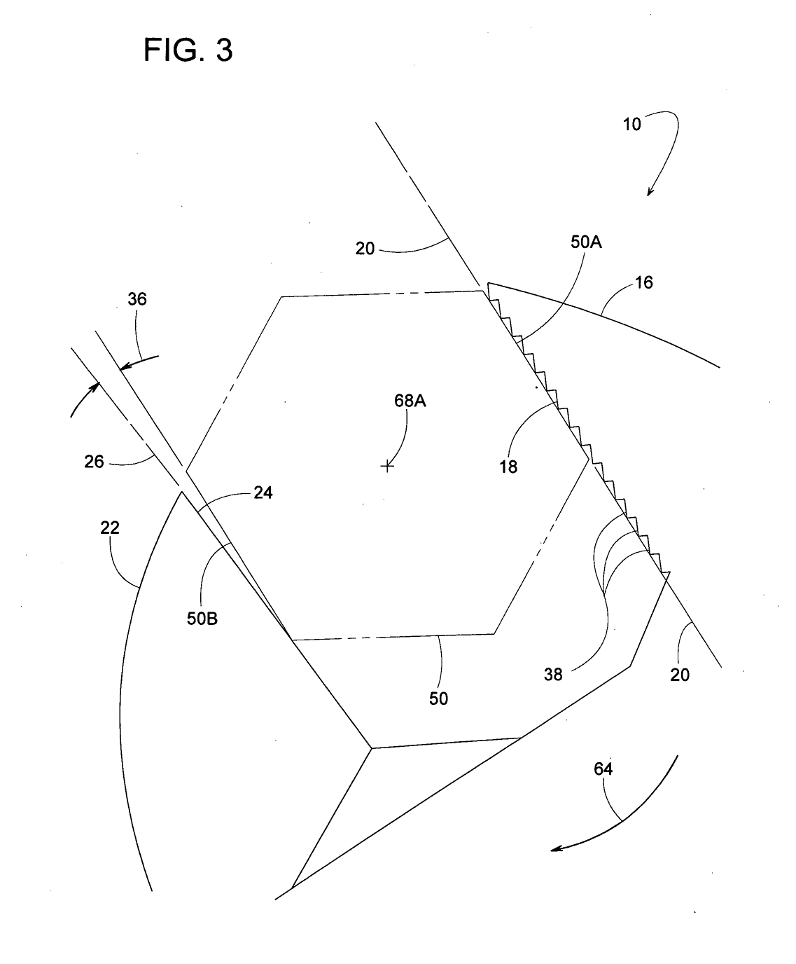

FIG. 3 shows the wrench's initial engagement with hexagon 50, wherein wrench 10 is in a first state of equilibrium. In this state, a first side 50a of hexagon 50 touches and lies along first plane 20, and an opposite side 50b of hexagon 50 touches second plane 26 yet is displaced out of parallel alignment with second plane 26. The angle of displacement is generally equal to jaw angle 36. The term, “side” of a hexagon includes the side's corner end points. The terms, “first side” and “opposite side” simply means that the two sides are substantially parallel and at opposite sides of the hexagon.

It is in FIG. 4 that hexagon 50 is defined in relation to wrench 10 being at some given open position, wherein the given open position can be, but is not necessarily, at the wrench's fully open position (maximum open position). Specifically, first jaw face 18 and second jaw face 24 define hexagon 50 at a first position as follows: first side 50a of hexagon 50 touches first plane 20 (e.g., point 44) and lies at jaw angle 36 relative first plane 20, and opposite side 50b of hexagon 50 lies against and substantially parallel to second jaw face 24 and terminates at distal tip 56 of second jaw face 24, wherein distal tip 24 is the point on second jaw face 24 (and on second plane 26) that is farthest away from vertex 52.

FIG. 4 shows wrench 10 in a second state of equilibrium. This second state of equilibrium can be reached by manually rotating wrench 10 in direction 64 (FIG. 3) relative to hexagon 50, whereby wrench 10 moves from its position of FIG. 3 to that of FIG. 4. In the second state of equilibrium, first side 50a of hexagon 50 touches first plane 20 (point 44) yet is displaced out of parallel alignment with first plane 20, and opposite side 50b of hexagon 50 touches and lies along second plane 26. The angular displacement of first side 50a and first plane 20 is generally equal to jaw angle 36.

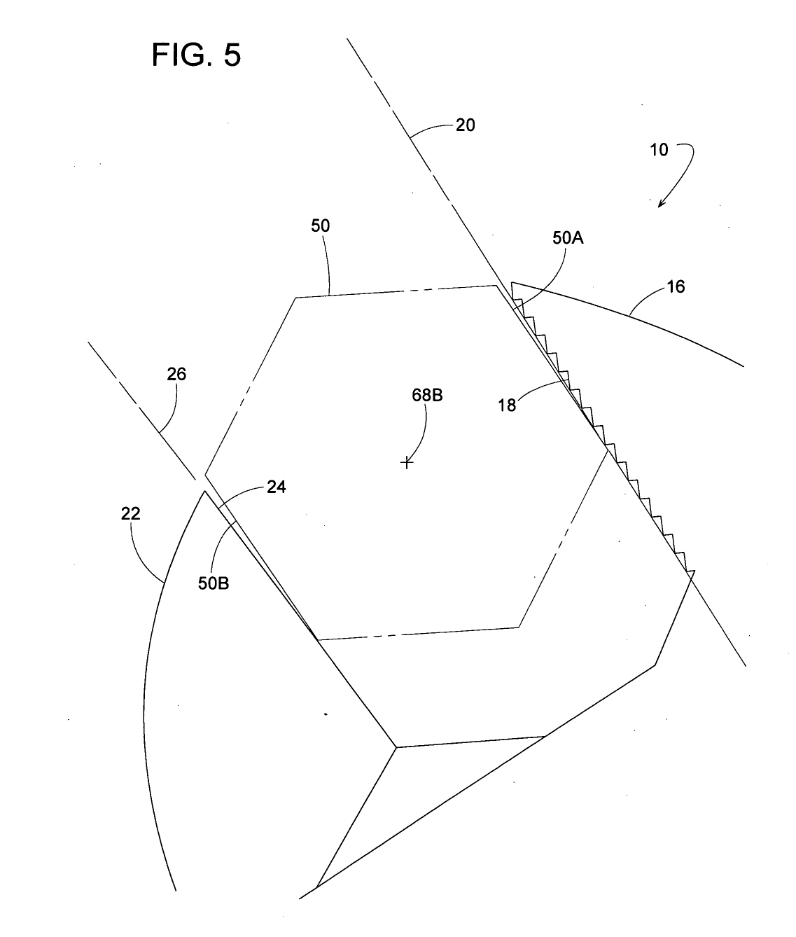

Upon wrench 10 rotating from its first state of equilibrium of FIG. 3 to its second state of equilibrium of FIG. 4, wrench 10 passes through an intermediate state shown in FIG. 5. In the intermediate state, first side 50a of hexagon 50 touches first plane 20 yet is displaced out of parallel alignment with first plane 20, and opposite side 50b of hexagon 50 touches second plane 24 yet is displaced out of parallel alignment with second plane 24.

It should be noted that in the intermediate state of FIG. 5, hexagon 50 is farther away from vertex 52 than when hexagon 50 was in either of the two equilibrium conditions of FIGS. 3 and 4. The difference in spacing between hexagon 50 and vertex 52 as wrench 10 moves to its various states is referred to as a snap-in distance 66, which is shown in FIG. 6. Snap-in distance 66 is measured with reference to the hexagon's center point moving between a first point 68a (FIGS. 3 and 4) to a second point 68b (FIG. 5). For smooth operation, snap-in distance 66 preferably is greater than half of pitch distance 64, and/or a settling-in ratio of snap-in distance 66 to a slide distance 70 is preferably greater than 0.250 and less than 0.260. Slide distance 70 is defined as the displaced distance of point 46 along a jaw face as hexagon 50 moves from the first state of equilibrium (FIG. 3) to the second state of equilibrium (FIG. 4). Slide distance 70, snap-in distance 66, and the settling-in ratio are defined and calculated with reference to ideal mathematical models, i.e., perfect hexagon, perfect jaw planes, and with no part deformation or strain.

Although snap-in distance 66 may or may not always provide a user with an actual tactile sensation that indicates that wrench 10 has moved from its point of initial contact (FIG. 3) to a point of firm engagement (FIG. 4), an additional benefit is that a real hexagonal bolt head tends to bind more tightly between jaws 16 and 22 as wrench 10 begins rotating in direction 64 from its position of FIG. 3. This binding action is due to jaw face 18 being rougher than jaw face 24. So, instead of an actual hexagonal head moving through the theoretical or mathematical positions of FIGS. 3-5, point 44 on hexagon 50 tends to “stick” or grip jaw face 18 while engagement point 46 on hexagon 50 tends to slide on jaw face 24. Regardless of the movement following an ideal mathematically defined path (i.e., FIGS. 3-6) or an actual path (with binding, strain and/or material deformation), hexagon 50 can maintain continuous contact with both jaw faces 18 and 24, thus avoiding the usual clearance play often experienced with conventional wrenches.

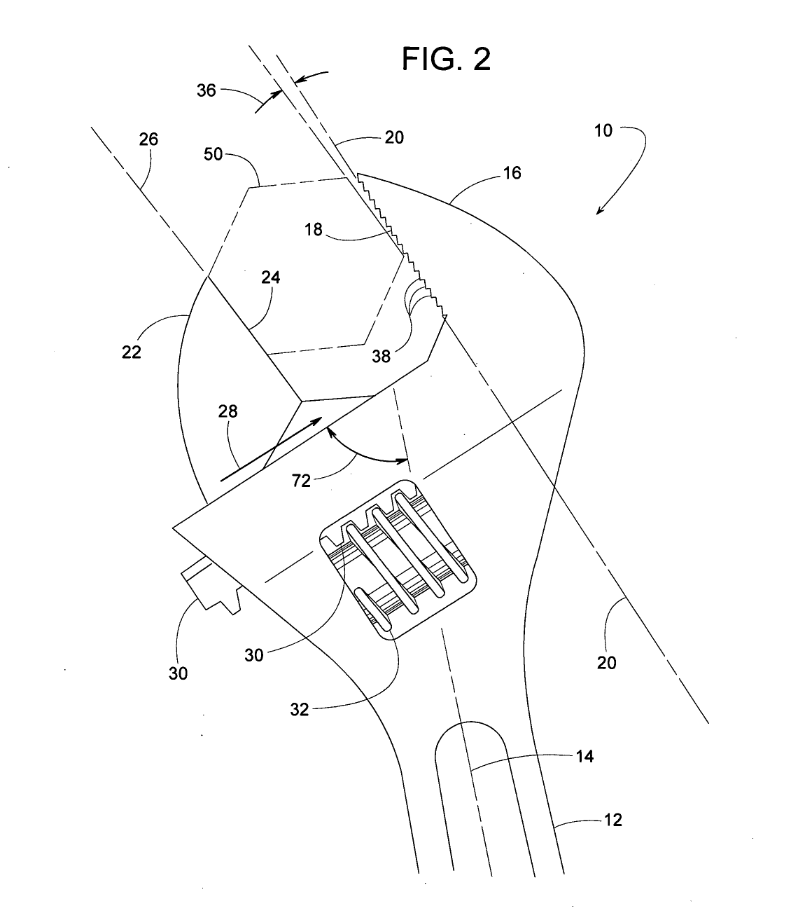

In some cases, to initiate the wrench's binding or gripping action, particularly in the case where the gripped head is rounded and relatively hard, some manual force may be needed to push wrench 10 onto the head. Exerting such manual force tends to be easier if handle 12 is pointing generally in the same direction as the force that pushes wrench 10 onto the head; otherwise, handle 12 could present a rotational moment with a lever arm that works against the user. To minimize this concern, adjustment direction 28 is at an adjustment angle 72 (FIG. 2) relative to longitudinal axis 14 of handle 12, wherein adjustment angle 72 is preferably 20 to 90 degrees.

It should be noted that all drawing figures, specified angles, and descriptions are with respect to jaws 16 and 22 being biased apart from each other (spread apart) to eliminate any backlash or incidental moving part clearances.

Although the invention is described with respect to a preferred embodiment, modifications thereto will be apparent to those of ordinary skill in the art. The scope of the invention, therefore, is to be determined by reference to the following claims:

1. A wrench definable with reference to a hexagon with opposite sides, the wrench comprising:
a handle;
a first jaw connected to the handle and having a first jaw face that defines a first plane; and
a second jaw connected to the handle and having a second jaw face that defines a second plane, wherein:
a) the second jaw face is appreciably smoother than the first jaw face;
b) the first plane is displaced out of parallel alignment with the second plane; and
c) the first plane and the second plane in relation to the hexagon interposed therebetween with the opposite sides generally facing the first jaw face and the second jaw face provides a settling-in ratio of greater than 0.250 and less than 0.260.

2. An adjustable wrench adapted to grip a polygonal head including, but not limited to, a hexagonal head, the adjustable wrench comprising:
a handle defining a longitudinal axis,
a first jaw connected to the handle and having a first jaw face that defines a first plane; and
a second jaw connected to the handle and having a second jaw face that defines a second plane, wherein:
a) the second jaw face is appreciably smoother than the first jaw face;
b) the first plane and the second plane diverge in a direction generally away from the handle to define a jaw angle of greater than zero degrees to less than fifteen degrees between the first plane and the second plane;
c) the second jaw is movable in translation along an adjustment direction relative to the first jaw; and
d) the adjustment direction is at an adjustment angle relative to the longitudinal axis of the handle, and the adjustment angle is twenty to ninety degrees.

3. The adjustable wrench of claim 2, wherein:
a) the second jaw terminates at a distal tip on the second plane;
b) the second jaw is movable to a fully open position;
c) the adjustable wrench has an overall length when the second jaw is at the fully open position;
d) the first plane and the second plane intersect at a vertex; and
e) when the second jaw is at the fully open position, a distance from the vertex to the distal tip is greater than half of the overall length of the adjustable wrench.

4. The adjustable wrench of claim 3, wherein the distance from the vertex to the distal tip is greater than the overall length of the adjustable wrench when the second jaw is at the fully open position.

5. The adjustable wrench of claim 2, wherein the jaw angle is two to eight degrees.

6. The adjustable wrench of claim 2, wherein the jaw angle is about 4 degrees.

7. The adjustable wrench of claim 2, wherein the second jaw face has a roughness average of less than 125 microinches.

8. The adjustable wrench of claim 2, further comprising a carbide-alloy coating on the first jaw.

9. The adjustable wrench of claim 2, wherein the first jaw face includes a plurality of teeth.

10. The adjustable wrench of claim 9, wherein the first plane and the second plane intersect at a vertex, and the plurality of teeth lean toward the vertex.

11. The adjustable wrench of claim 2, wherein a number of jaws on the adjustable wrench is limited to just the first jaw and the second jaw.

12. An adjustable wrench, comprising:
a handle;
a first jaw connected to the handle and having a first jaw face that defines a first plane; and
a second jaw connected to the handle and having a second jaw face that defines a second plane, the second jaw face terminates at a distal tip on the second plane, the second jaw face is smoother than the first jaw face, the second jaw is movable in translation to a given open position relative to the first jaw such that at the given open position:
a) the first jaw face is spaced apart from the second jaw face;
b) the first plane and the second plane define a jaw angle therebetween of greater than zero degrees and less than fifteen degrees;
c) the first plane and the second plane intersect at a vertex, wherein the distal tip is a point on the second jaw face that is farthest away from the vertex;
d) the first jaw face and the second jaw face define a hexagon at a first position as follows: a first side of the hexagon touches the first plane and lies at the angle of greater than zero degrees and less than fifteen degrees relative thereto, and an opposite side of the hexagon lies against and substantially parallel to the second jaw face and terminates at the distal tip;
e) the hexagon is indexable to a second position relative to the adjustable wrench wherein the first side of the hexagon lies along the first plane, and the second side of the hexagon touches the second plane and lies at the angle of greater than zero degrees and less than fifteen degrees relative thereto; and
f) the hexagon relative to the adjustable wrench is movable to an intermediate position between the first position and the second position such that the first side of the hexagon touches the first plane and is displaced out of parallel alignment therewith, the opposite side touches the second plane and is displaced out of parallel alignment therewith, and the hexagon in the intermediate position is farther away from the vertex than when the hexagon is in the first position, and the hexagon in the intermediate position is farther away from the vertex than when the hexagon is in the second position.

13. The adjustable wrench of claim 12, wherein:
a) the second jaw is movable to a fully open position;
b) the adjustable wrench has an overall length when the second jaw is at the fully open position;
c) when the second jaw is at the fully open position, a distance from the vertex to the distal tip is greater than half of the overall length of the adjustable wrench.

14. The adjustable wrench of claim 13, wherein the distance from the vertex to the distal tip is greater than the overall length of the adjustable wrench when the second jaw is at the fully open position.

15. The adjustable wrench of claim 12, wherein the jaw angle is two to eight degrees.

16. The adjustable wrench of claim 1121, wherein the second jaw face has a roughness average of less than 125 microinches.

17. The adjustable wrench of claim 12, wherein the first jaw face includes a plurality of teeth.

18. The adjustable wrench of claim 17, wherein:
a) the plurality of teeth are spaced at a pitch distance;
b) the hexagon in the intermediate position is farther away, by a snap-in distance, from the vertex than when the hexagon is in the first position; and
c) the snap-in distance is greater than half the pitch distance.

19. The adjustable wrench of claim 12, wherein the hexagon relative to the adjustable wrench can move from the first position to the second position while the first side of the hexagon remains in contact with the second jaw face and while the opposite side of the hexagon remains in contact with the first jaw face.

20. An adjustable wrench adapted to grip a polygonal head including, but not limited to a polygonal head that defines a hexagon having a first side and an opposite side, the adjustable wrench comprising:
a handle;
a first jaw extending from the handle, the first jaw includes a first jaw face defining a first plane;
a second jaw extending from the handle, the second jaw includes a second jaw face defining a second plane, the second jaw face generally faces the first jaw face and is adapted to engage the polygonal head when the polygonal head is inserted between the first jaw face and the second jaw face, wherein:
a) one of the first jaw face and the second jaw face is appreciably smoother than the other;
b) the first plane and the second plane are displaced out of parallel alignment with each other such that the first plane and the second plane intersect at a vertex and diverge in a direction generally away from the handle, thus the first plane and the second plane have an angled relationship; and
c) the angled relationship provides selectively a first state of equilibrium, a second state of equilibrium, and an intermediate state with reference to the hexagon such that:
i. in the first state of equilibrium, the first side of the hexagon touches and lies along the first plane, and the opposite side of the hexagon touches the second plane yet is displaced out of parallel alignment with the second plane;
ii. in the second state of equilibrium, the first side of the hexagon touches the first plane yet is displaced out of parallel alignment with the first plane, and the opposite side of the hexagon touches and lies along the second plane;
iii. in the intermediate state, the first side of the hexagon touches the first plane yet is displaced out of parallel alignment with the first plane, the opposite side of the hexagon touches the second plane yet is displaced out of parallel alignment with the second plane, and
iv. the hexagon is farther away from the vertex in the intermediate state than in the first state of equilibrium, and the hexagon is farther away from the vertex in the intermediate state than in the second state of equilibrium.
